(19) United States
(12) Patent Application Publication
(10) Pub. No.: US 2025/0306330 A1
(43) Pub. Date: Oct. 2, 2025

(54) LENS UNIT

(71) Applicant: DAICEL CORPORATION, Osaka-shi, Osaka (JP)

(72) Inventors: Hiroyuki HANATO, Tokyo (JP); Rikiya KAMIDATE, Tokyo (JP)

(73) Assignee: DAICEL CORPORATION, Osaka-shi, Osaka (JP)

(21) Appl. No.: 18/863,981

(22) PCT Filed: Jun. 29, 2023
(86) PCT No.: PCT/JP2023/024155

§ 371 Date: Nov. 7, 2024

(30) Foreign Application Priority Data
Jul. 5, 2022 (JP) 2022-108334

(51) Int. Cl. G02B 7/02; G02B 13/00; G03B 17/12

(52) U.S. Cl. CPC G02B 7/025; G02B 7/021; G02B 7/028; G02B 13/0055; G03B 17/12

(57) ABSTRACT

Provided is a lens unit in which when a lens is fixed to a mirror frame via an adhesive.

### TECHNICAL FIELD

The present disclosure relates to a lens unit. The present application claims priority to JP 2022-108334, filed in Japan on Jul. 5, 2022, the content of which is incorporated herein.

### BACKGROUND ART

In recent years, an increase in number of pixels of an imaging device mounted on an electronic device has been progressing, and a superior resolving power is desired for a lens module thereof. A lens unit including a lens in a holder (mirror frame) is used for the lens module. Since the lens unit is assembled on a substrate on which an imaging element chip is mounted, it is important that an optical axis of the lens is positioned in the holder without being inclined with respect to the imaging element chip. As such a positioning technique, an inner surface of the holder and an outer circumferential surface of the lens are fixed inside the holder without a gap (see Patent Document 1).

Introduction of a reflow process is economical for mounting an electronic component on a substrate. However, in a lens positioned such that a gap does not occur between the holder inner surface and the lens outer circumferential surface, when a lens unit is assembled on the substrate and then subjected to the reflow process, due to a difference in thermal expansion coefficient between the lens and the holder, the lens thermally expands and is strongly pressed against an inner circumferential surface of the holder, and thus deformation and cracking occur, significantly deteriorating lens performance and assembling accuracy, and as a result, there is a problem that a focal length with an imaging element also deviates.

Patent Document 2 proposes a structure in which an elastic body is sandwiched between a lens and a holder to absorb thermal expansion. Patent Documents 3 to 5 disclose a lens unit in which a gap is present between an inner surface of the holder and an outer circumferential surface of the lens such that a lens and a holder are fixed to each other via an adhesive.

### CITATION LIST

### Patent Document

Patent Document 1: JP 2010-156887 A
Patent Document 2: JP 2009-258560 A
Patent Document 3: JP 2009-98614 A
Patent Document 4: JP 61-123809 A
Patent Document 5: JP 61-121019 A

### SUMMARY OF INVENTION

### Technical Problem

However, since the lens unit of Patent Document 2 requires the elastic body, there is a problem that the number of components and cost increases. The known lens unit in which the lens and the holder are fixed to each other via the adhesive has a problem that the lens is inclined and this causes the optical axis to be inclined or that cracking occurs in the lens due to variation in thickness of an adhesive layer caused by uneven application of the adhesive or shrinkage during curing depending on an application mode of the adhesive. In particular, in the lens unit of Patent Document 3, since the adhesive is applied between the inner surface of the holder and the outer circumferential surface of the lens, the lens may be pulled in an outer circumferential direction and cracking may occur when the adhesive shrinks. An advanced technique is required for operation during application of the adhesive such that the adhesive does not adhere to any unnecessary portions.

Therefore, an object of the invention according to the present disclosure is to provide a lens unit in which, when a lens is fixed to a mirror frame via an adhesive, an optical axis is less likely to be inclined, cracking is less likely to occur, a focal length is less likely to deviate, and the lens unit can be easily manufactured, even in a high-temperature environment.

### Solution to Problem

As a result of deliberate study to achieve the above object, the inventors of the present disclosure have found that according to a lens unit in which a gap is present between an inner wall of a tubular portion of a mirror frame and an outer circumference of a lens, and a lid-side end surface of a flange portion of the lens extending to an outer circumferential side of the lens portion has, respectively on surfaces parallel to each other or the same plane, an adhesion region adhering to a lid of the mirror frame via an adhesive and an abutment region in surface contact with the lid, even in a high-temperature environment when the lens is fixed to a holder via the adhesive, an optical axis is less likely to be inclined, cracking is less likely to occur, a focal length is less likely to deviate, and the lens unit can be easily manufactured. The present disclosure relates to the solution achieved based on these findings.

That is, the present disclosure provides a lens unit including a mirror frame and a lens accommodated in the mirror frame, in which the mirror frame includes a tubular portion in which the lens is accommodated and a lid covering one opening of the tubular portion and including a hole centered on an optical axis of the lens, the lens includes a lens portion and a flange portion extending to an outer circumference of the lens portion, a gap is present between an inner wall of the tubular portion and an outer circumference of the lens, and the lid-side end surface of the flange portion includes, respectively on surfaces parallel to each other or the same plane, an adhesion region adhering to the lid via an adhesive and an abutment region in surface contact with the lid.

In the lens unit, since a gap is present between the inner wall of the tubular portion of the mirror frame and the outer circumference of the lens, the lens does not come into contact with the inner wall of the tubular portion, and cracking is less likely to occur in the lens, even when the lens thermally expands in a high-temperature environment. Since the lid-side end surface of the flange portion has, respectively on surfaces parallel to each other or the same plane, the adhesion region adhering to the lid via the adhesive and the abutment region in surface contact with the lid, the abutment region serves as a holding part, and thus the lens does not approach the lid and a focal length is maintained, even when the adhesive shrinks at the time of curing or the like. Since the adhesion region and the abutment region are respectively on the surfaces parallel to each other or on the same plane, the lens is less likely to be inclined, and thus the optical axis is less likely to be inclined. Since the lens unit does not require an elastic body for suppressing cracking, the lens unit can be easily manufactured.

The adhesion region and the abutment region are preferably formed perpendicular to an optical axis direction. With such a structure, even when the adhesive shrinks, the abutment region more firmly acts as a holding part, the focal length is less likely to deviate, and the optical axis is less likely to be inclined.

It is preferable that the flange portion has a protrusion on an outer circumference and has the adhesion region at the protrusion, the protrusion protruding toward the lid. With such a configuration, it is possible to make it more difficult for the adhesive to flow toward the lens portion.

It is preferable that an inner circumferential side surface of the protrusion does not adhere to the lid portion. With such a configuration, it is possible to prevent the lens from being pulled toward the outer circumferential side or the inner circumferential side due to expansion or shrinkage of the adhesive, and cracking from occurring.

The abutment region is preferably located on an outer circumferential side of the adhesion region. With such a configuration, it is possible to make deviation (lateral deviation) in an XY direction (direction perpendicular to the optical axis) less likely to occur.

The lid preferably includes a plate portion extending from an inner wall of the tubular portion in a direction of the hole and including a plane on the lens side of the plate portion, and a protruding portion extending from the plate portion in the direction of the hole and in a direction of the lens. With such a configuration, it is possible to make deviation (lateral deviation) in the XY direction (direction perpendicular to the optical axis) less likely to occur.

It is preferable that the flange portion includes a protrusion on an outer circumference, the protrusion protruding toward the lid. It is also preferable that an inner circumferential side surface of the protrusion abuts against the protruding portion. With such a configuration, it is possible to make deviation (lateral deviation) in the XY direction (direction perpendicular to the optical axis) less likely to occur.

It is preferable that the flange portion has a protrusion on an outer circumference and has the adhesion region at the protrusion, the protrusion protruding toward the lid. It is also preferable that the protruding portion of the lid and the flange portion of the lens are fitted to each other. With such a configuration, it is possible to make deviation (lateral deviation) in the XY direction (direction perpendicular to the optical axis) less likely to occur.

It is preferable that the lens unit is for reflow mounting.

The present disclosure provides a lens module including a substrate and the lens unit, the lens module having a structure in which the lens unit is mounted on the substrate.

The lens module may include an infrared filter installed at a position covering the hole.

The present disclosure also provides a camera module including the lens module.

The present disclosure provides a method of manufacturing a lens module including mounting the lens unit on a substrate through reflow soldering.

### Advantageous Effects of Invention

In the lens unit of the present disclosure, when the lens is fixed to the holder via the adhesive, the optical axis is less likely to be inclined, cracking is less likely to occur, the focal length is less likely to deviate, and the lens unit can be easily manufactured, even in a high-temperature environment.

### BRIEF DESCRIPTION OF DRAWINGS

FIG. 1 is a cross-sectional view illustrating an embodiment of a lens unit of the present disclosure.

FIG. 2 is an enlarged view of a lens 3 in a lens unit 1 illustrated in FIG. 1.

FIG. 3 is a cross-sectional view illustrating another embodiment of the lens unit of the present disclosure.

FIG. 4 is a cross-sectional view illustrating still another embodiment of the lens unit of the present disclosure.

FIG. 5 is an external view illustrating an embodiment of a lens module of the present disclosure.

FIG. 6 is a cross-sectional view illustrating an embodiment of the lens module of the present disclosure.

FIG. 7 is a cross-sectional view illustrating another embodiment of the lens module of the present disclosure.

FIG. 8 is a cross-sectional view illustrating an embodiment of a lens module group including the lens module of the present disclosure.

FIG. 9 is a cross-sectional view illustrating another embodiment of the lens module group including the lens module of the present disclosure.

### DESCRIPTION OF EMBODIMENTS

### Lens Unit

A lens unit according to an embodiment of the present disclosure includes at least a mirror frame and a lens accommodated in the mirror frame.

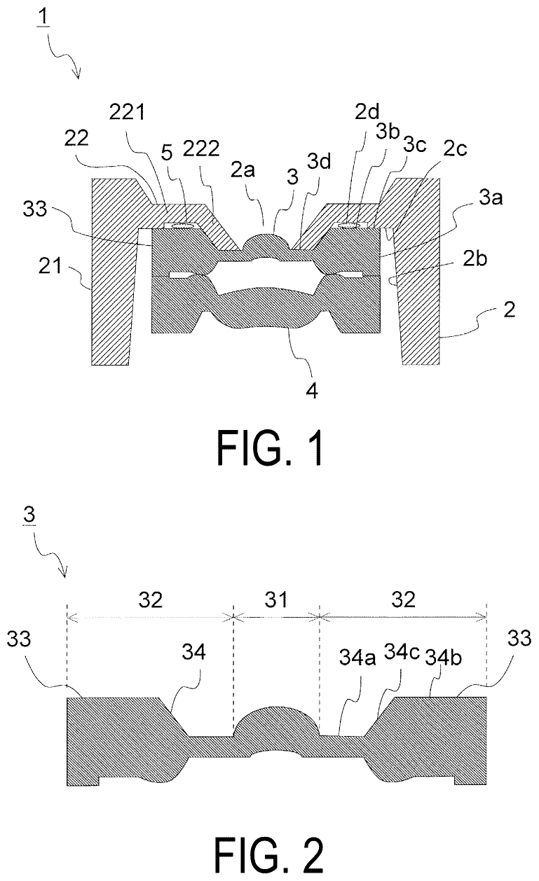

FIG. 1 is a cross-sectional view illustrating an embodiment (first embodiment) of the lens unit of the present disclosure. A lens unit 1 illustrated in FIG. 1 includes a mirror frame 2, a lens 3, and a lens 4.

The lenses 3 and 4 are accommodated in the mirror frame 2. The mirror frame 2 includes a tubular portion 21 and a lid 22 that covers one opening of the tubular portion 21. The tubular portion 21 accommodates the lenses 3 and 4 therein. The lid 22 has a hole 2a centered on an optical axis of the lenses 3 and 4 for allowing external light to pass through lens portions of the lenses 3 and 4.

The tubular portion 21 only needs to have a cavity for accommodating the lenses therein, and shapes of its outer frame and the cavity are not particularly limited. Examples of the shapes include a cylinder, a prism, and a tapered shape. The shape of the cavity and the shape of the outer frame may be the same or different.

The lid 22 includes a plate portion 221 extending from an inner wall 2b of the tubular portion 21 in a direction of the hole 2a (that is, the central direction of the lid 22), and a protruding portion 222 extending from the plate portion 221 in a direction of the hole 2a and in a direction of the lens 3. With such a configuration, it is possible to make deviation (lateral deviation) in the XY direction (direction perpendicular to the optical axis) less likely to occur. The lid 22 need not include both the plate portion 221 and the protruding portion 222, and may include only either one. The plate portion 221 and the protruding portion 222 are formed in an annular shape and thus forms a circumference of the hole 2a without a gap.

The plate portion 221 includes a plane on the lens 3 side thereof (that is, an inner side of the tubular portion 21). The plate portion 221 illustrated in FIG. 1 has two planes at different positions in an optical axis direction (Z direction) with a step interposed therebetween on the lens 3 side thereof. The number of planes of the plate portion 221 is not particularly limited. The plane is perpendicular to the optical axis: however, the plane may be inclined. The plane has a region that is in surface contact with a lid-side end surface 34 of a flange portion 32 of the lens 3, and has a region adhering to the lid-side end surface 34 via the adhesive 5. Specifically, a first plane 2c having a region in surface contact with the lid-side end surface 34 and a second plane 2d having a region adhering to the lid-side end surface 34 via the adhesive 5 are provided in this order with the first plane 2c being closer to the inner wall 2b of the tubular portion 21. The second plane 2d has a step with the first plane 2c and forms a recess in the plate portion 221. The recess is filled with the adhesive 5, and the lid 22 adheres to the lid-side end surface 34 via the adhesive 5.

The protruding portion 222 extends from the plate portion 221 in a direction of the hole 2a and in a direction of the lens 3, and is inclined from a distal end of the plate portion 221 toward a lens portion 31 of the lens 3. The protruding portion 222 extends at least in the direction of the lens 3 and need not extend in the direction of the hole 2a. Furthermore, the protruding portion 222 may extend in the direction of the lens 3 not from the distal end of the plate portion 221 but from midway, and need not be inclined. A distal end of the protruding portion 222 on the lens 3 side thereof has a plane perpendicular to the optical axis. The plane has a region in surface contact with the lid-side end surface 34 of the flange portion 32 of the lens 3. The distal end of the protruding portion 222 on the lens 3 side thereof need not have a plane. The plane of the distal end on the lens 3 side thereof need not be perpendicular to the optical axis, and may be inclined.

The lens 3 will be described with reference to FIG. 2. FIG. 2 is an enlarged view of the lens 3 in the lens unit 1 illustrated in FIG. 1. The lens 3 includes the lens portion 31, and the flange portion 32 connected to the lens portion 31 and extending to an outer circumference of the lens portion 31. A lens portion is a portion that refracts light and diverges or converges the light. The lens portion 31 is a convex lens that is convex toward the lid 22, but may be a concave lens or an annular convex lens.

The flange portion 32 is a portion (non-lens portion) that does not refract light and does not diverge or converge the light. The flange portion 32 has, on its outer circumference, a protrusion 33 protruding toward the lid 22. The surface (lid-side end surface) 34 of the flange portion 32 on the lid 22 side has a first end surface 34a and a second end surface 34b on the protrusion 33 in this order from the lens portion 31 toward the outer circumference. The surface 34 further has a third end surface 34c which is an inner circumferential side surface of the protrusion and is located between the first end surface 34a and the second end surface 34b. The first end surface 34a and the second end surface 34b are parallel to each other, and are perpendicular to the optical axis in a state adhering to the lid 22. A height of the second end surface 34b is greater than a height of the lens portion 31 (that is, the second end surface 34b is located at a position close to the lid 22).

As illustrated in FIG. 1, the lens 3 adheres to the lid 22 of the mirror frame 2 via the adhesive 5. Specifically, the recess where the second plane 2d is present on an inner side of the plate portion 221 is filled with the adhesive 5. The second end surface 34b of the lens 3 has an adhesion region 3b that adheres to the second plane 2d while partially adhering to the adhesive 5. The second end surface 34b of the lens 3 partially has an abutment region 3c that is in surface contact with and abuts against the first plane 2c on the inner side of the plate portion 221. The first end surface 34a of the lens 3 has an abutment region 3d that is in surface contact with and abuts against the distal end of the protruding portion 222 on the lens 3 side thereof. The third end surface (the inner circumferential side surface of the protrusion 33) 34c of the lens 3 has an abutment region that is in surface contact with and abuts against the inner side end surface of the protruding portion 222, and the entire surface of the abutment region abuts against the inner side end surface of the protruding portion 222. In this manner, the protruding portion 222 of the lid 22 and the flange portion 32 of the lens 3 are fitted to each other. By the third end surface 34c abutting against the protruding portion 222, it is possible to make deviation (lateral deviation) in the XY direction (direction perpendicular to the optical axis) less likely to occur. “Abutment region” in the present specification refers to a region where two members are in contact with each other, and refers to a region that is not fixed through adhesion, welding, or the like.

The lens unit 1 has the adhesion region 3b on the protrusion 33 of the flange portion 32. With such a configuration, it is possible to make it more difficult for the adhesive to flow toward the lens portion. The third end surface (the inner circumferential side surface of the protrusion 33) 34c of the lens 3 has an abutment region that is in surface contact with and abuts against the inner side end surface of the protruding portion 222, and does not adhere to the lid portion 22. With such a configuration, it is possible to prevent the lens 3 from being pulled toward the outer circumferential side or the inner circumferential side due to expansion or shrinkage of the adhesive, and cracking from occurring.

The second plane 2d may be provided continuously in an annular shape along a circumferential direction, and a plurality of the second planes 2d may be provided intermittently. The adhesive 5 is applied to a region including the center (midpoint between an inner circumferential end and an outer circumferential end) of the second plane 2d.

As described above, the second end surface (the end surface of the protrusion 33 on the lid 22 side) 34b has the adhesion region 3b and the abutment region 3c on the same plane perpendicular to the optical axis. The abutment region 3c is located on an outer circumferential side of the adhesion region 3b. With such a configuration, it is possible to make deviation (lateral deviation) in the XY direction (direction perpendicular to the optical axis) less likely to occur. The first end surface 34a has the abutment region 3d, and the lens unit 1 has the adhesion region 3b and the abutment region 3d respectively on surfaces parallel to each other which are perpendicular to the optical axis. The abutment region 3d is located on an inner circumferential side of the adhesion region 3b. In the lens unit of the present disclosure, the abutment region may be provided on at least one of the inner circumferential side or the outer circumferential side of the adhesion region, or may be provided on both sides.

The lens 4 is stacked on the lens 3, and adheres to the flange portion 32 of the lens 3 on a side opposite to the side close to the lid 22. The lens 3 and the lens 4 may adhere to each other via an adhesive or may adhere to each other without the adhesive. A type of the lens portion of the lens 4 (such as convex lens) is not particularly limited. The lens unit of the present disclosure only needs to include at least the lens 3 adhering to the lid 22, need not include the lens 4, and a lens may further be stacked in addition to the lenses 3 and 4.

In the lens unit 1, a gap is present between the inner wall 2b of the tubular portion 21 and an outer circumference 3a of the lens 3. A gap is also present between the inner wall 2b of the tubular portion 21 and an outer circumference of the lens 4. In the lens unit of the present disclosure, it is preferable that all lenses located at an inner portion of the tubular portion 21 have a gap from the inner wall 2b of the tubular portion 21.

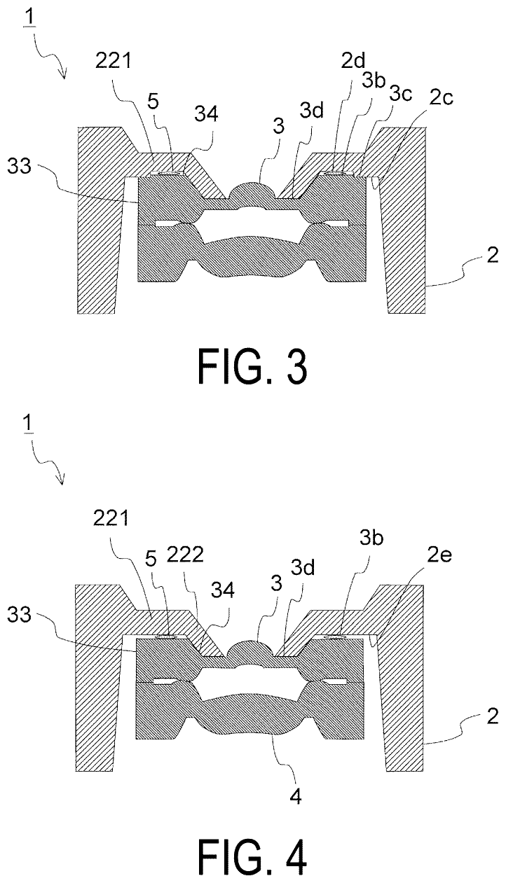

FIG. 3 illustrates another embodiment (second embodiment) of the lens unit of the present disclosure. A lens unit 1 illustrated in FIG. 3 is different from the lens unit 1 illustrated in FIG. 1 in that an adhesion region 3b and an abutment region 3c are not on the same plane but on different parallel surfaces with a step interposed therebetween on a lid-side end surface 34 of a protrusion 33 in a lens 3. In the lens unit 1 illustrated in FIG. 3, the lid-side end surface 34 of the protrusion 33 having the abutment region 3c abuts against a first plane 2c on an inner side of a plate portion 221, and the lid-side end surface 34 of the protrusion 33 having the adhesion region 3b enters a recess where a second plane 2d is on the inner side of the plate portion 221 and adheres to the second plane 2d via an adhesive 5. The other points are similar to those of the lens unit 1 illustrated in FIG. 1.

FIG. 4 illustrates still another embodiment (third embodiment) of the lens unit of the present disclosure. In a lens unit 1 illustrated in FIG. 4, an inner surface of a plate portion 221 has a single plane 2e. A lid-side end surface 34 of a protrusion 33 in a lens 3 has an adhesion region 3b adhering to a plane 2e on the inner side of the plate portion 221 via an adhesive 5, and the abutment region on a surface parallel to or on the same plane as the adhesion region 3b is only an abutment region 3d on the inner circumferential side of the adhesion region 3b, and has no abutment region on the outer circumferential side of the adhesion region 3b. The other points are similar to those of the lens unit 1 illustrated in FIG. 1.

In the lens unit 1, since a gap is present between the inner wall 2b of the tubular portion 21 of the mirror frame 2 and the outer circumference 3a of the lens 3, the lens 3 does not come into contact with the inner wall 2b of the tubular portion 21, and cracking is less likely to occur in the lens 3, even when the lens 3 thermally expands in a high-temperature environment. Since the lid-side end surface 34 of the flange portion 32 has, respectively on surfaces parallel to each other or the same plane, the adhesion region 3b adhering to the lid 22 via the adhesive 5 and the abutment regions 3c and 3d in surface contact with the lid 22, even when the adhesive shrinks at the time of curing or the like, the abutment regions 3c and 3d serve as holding parts, and thus the lens 3 does not approach the lid 22 and a focal length is maintained. Since the adhesion region 3b and the abutment regions 3c and 3d are respectively on the surfaces parallel to each other or on the same plane, the lens 3 is less likely to be inclined, and thus the optical axis is less likely to be inclined. Since the lens unit 1 does not require an elastic body for suppressing cracking, the lens unit 1 can be easily manufactured.

The mirror frame 2 and a lens such as the lens 3 can be each manufactured using known materials and manufacturing methods. The lens unit 1 can be manufactured by, for example, applying an adhesive to a region constituting the adhesion region 3b on the inner side of the lid 22, attaching the lens 3 to the adhesive in the adhesion region of the lid 22 and forming the abutment region, and then curing the adhesive by ultraviolet irradiation or heating as necessary to form the adhesive 5. The material of the lens is not particularly limited, and examples thereof include resin and glass. Examples of the adhesive include curable resins such as thermosetting resins and ultraviolet curable resins.

It is preferable that the lens unit can be mounted on a substrate together with other components through a high-temperature heat treatment (for example, reflow soldering). That is, it is preferable that the lens unit is for reflow mounting. When the lens unit has sufficient heat resistance for a case in which the lens unit is mounted on the substrate through a high-temperature heat treatment (for example, a high-temperature treatment at 260° C. or higher such as reflow soldering), reflow mounting is possible. In a device including the lens unit (for example, a lens module to be described later or an optical device including the lens module), the above-described device does not need to be mounted in a separate step, and the device including the lens unit can be mounted on a substrate together with other components through a high-temperature heat treatment (for example, reflow soldering), and can be manufactured efficiently and at a low cost.

### Lens Module

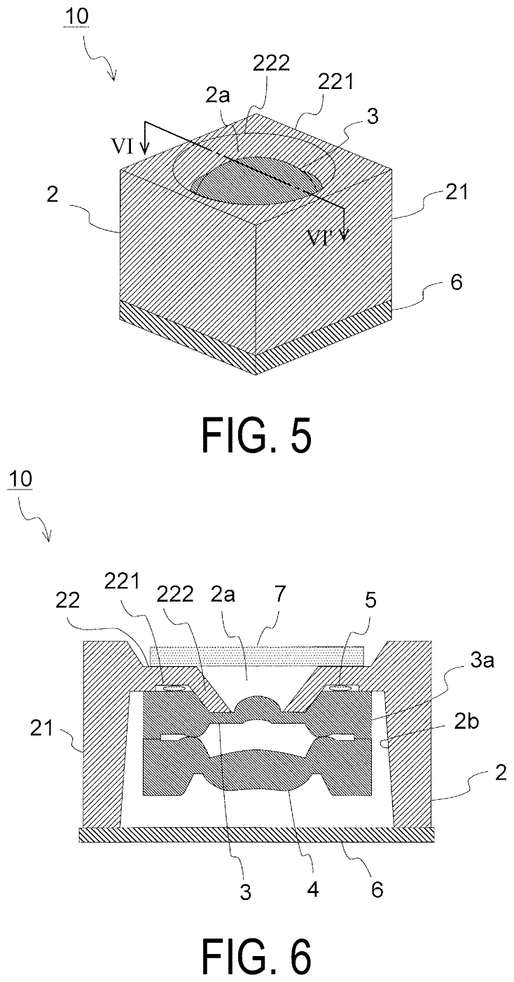

A lens module can be manufactured by forming the lens unit on a substrate. FIG. 5 is an external view illustrating an embodiment of the lens module using the lens unit illustrated in FIG. 1.

A lens module 10 illustrated in FIG. 5 includes a substrate 6 and the mirror frame 2 installed on the substrate 6. The mirror frame 2 is installed on the substrate 6, and the substrate 6 directly or indirectly supports the mirror frame 2. The substrate 6 covers the other opening of the tubular portion 21. That is, the lens module 10 includes the substrate 6 and the lens unit 1, and has a structure in which the lens unit 1 is mounted on the substrate 6. The lens module 10 may include an infrared filter (IR filter) installed at a position covering the hole 2a.

FIG. 6 is a cross-sectional view illustrating an embodiment of the lens module using the lens unit 1 illustrated in FIG. 1. FIG. 6 corresponds to an aspect in which an infrared filter 7 is installed and thus closes the hole 2a in a VI-VI′ cross section of the lens module 10 illustrated in FIG. 5. The lens module 10 preferably includes a sensor. A sensor may be installed on the substrate 6, or the substrate 6 may also include a sensor. In FIG. 6, the infrared filter 7 is installed at a position covering the hole 2a of the lid 22, and may be installed and thus cover the sensor, that is, may be installed between the sensor and the lens 3, for example, on the substrate 6.

The substrate and the tubular portion may adhere to each other via an adhesive or may adhere to each other without the adhesive. In the lens module 10 illustrated in FIG. 6, the substrate 6 and the tubular portion 21 adhere to each other without an adhesive, and can adhere to each other through reflow soldering, for example. The lens module 10 in which the lens unit 1 is mounted on the substrate 6 can be manufactured through reflow soldering.

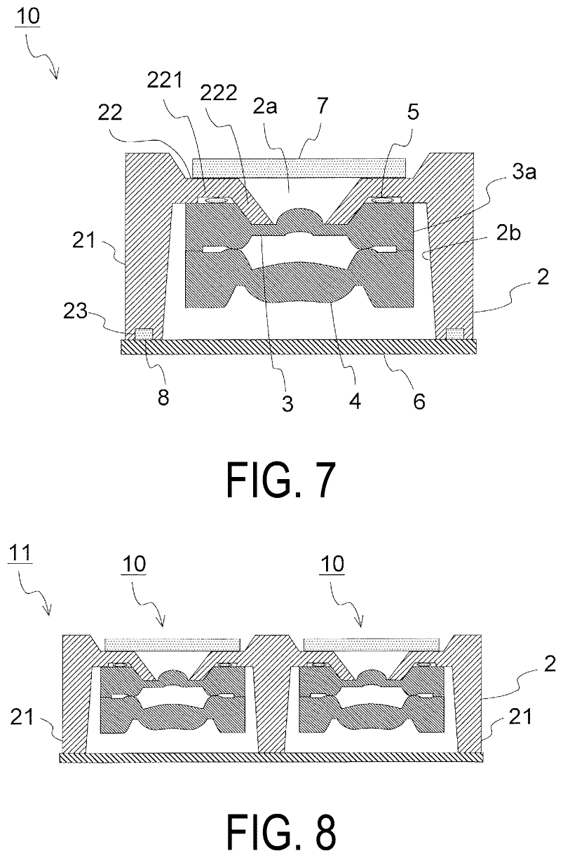

FIG. 7 is a cross-sectional view illustrating another embodiment of a lens module using the lens unit 1 illustrated in FIG. 1. In the lens module 10 of FIG. 7, the substrate 6 and the tubular portion 21 adhere to each other via an adhesive 8. A recess 23 provided in the bottom surface of the tubular portion 21 is filled with the adhesive 8, and the substrate 6 and the tubular portion 21 adhere to each other via the adhesive 8. The other points are similar to those of the lens module 10 illustrated in FIG. 6. The lens module illustrated in FIG. 7 can be manufactured by, for example, filling the recess 23 of the tubular portion 21 with an adhesive, attaching the bottom surface of the tubular portion 21 and the substrate 6 to each other via the adhesive, and curing the adhesive by ultraviolet irradiation or heating as necessary to form the adhesive 8. The recess 23 may be provided continuously in an annular shape along the circumferential direction, and a plurality of the recesses 23 may be provided intermittently. The recess 23 need not be provided in the bottom surface of the tubular portion 21, in this case, for example, an adhesive may be applied partially or entirely to the bottom surface of the tubular portion 21, and the substrate 6 and the tubular portion 21 may adhere to each other via the adhesive.

The lens modules are usable in a variety of equipment or devices to be equipped with an imaging-device lens module, where the equipment or devices are exemplified typically by cameras, computers, word processors, printers, copying machines, facsimile machines, telephones, mobile devices (such as cellular phones, smartphones, game equipment, tablet computers and other personal digital assistants (PDAs)), automobile equipment, building-use equipment, and astronomical equipment. In particular, the lens modules are useful as lenses (what is more, high-precision lenses) for compact imaging devices, exemplified by lens modules for imaging devices such as camera modules such as compact cameras (e.g., cellular phone cameras (cameras of so-called camera-equipped cellular phones) and on-vehicle camera modules). The compact camera lenses as above may each have a width (or diameter) of about 10 mm or less.

In the lens module (particularly, camera module), two or more lens modules may be used adjacent to each other. All of the two or more lens modules may be the lens module of the present disclosure, or one or more may be the lens module of the present disclosure and one or more may be another lens module. The three or more lens modules may be arranged on a straight line or may be arranged two-dimensionally.

FIG. 8 illustrates a cross-sectional view of a lens module group in which two lens modules of the present disclosure are provided adjacent to each other. The lens module group 11 of FIG. 8 is a camera module, two lens modules 10 are arranged adjacent to each other, the mirror frame 2 includes two tubular portions 21, and the two tubular portions 21 share a part of the wall of the tubular portion 21. With such a configuration, it is possible to save space when two or more lens modules are arranged.

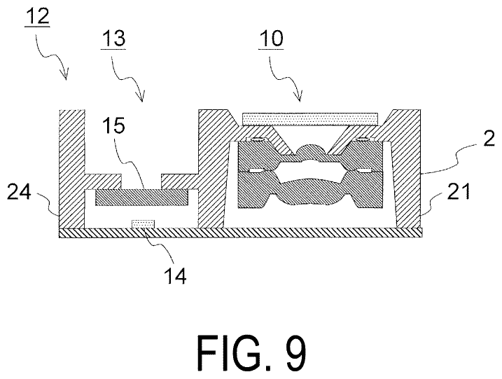

FIG. 9 illustrates a cross-sectional view of a lens module group in which the lens module of the present disclosure and a light emitting module that is another lens module are provided adjacent to each other. A lens module group 12 in FIG. 9 is a camera module, and the lens module 10 and a lens module 13 as a light emitting module are arranged adjacent to each other. The lens module 13 is a laser module using a laser as a light source 14, and includes a diffusion lens 15 that diffuses laser light emitted from the light source 14. The mirror frame 2 includes two tubular portions 21 and 24, and the two tubular portions share a wall of a part of the tubular portion. With such a configuration, it is possible to save space when two or more lens modules are arranged.

Each aspect disclosed in the present specification can be combined with any other feature disclosed herein. Note that each of the configurations, combinations thereof, or the like in each of the embodiments are examples, and additions, omissions, replacements, and other changes to the configurations may be made as appropriate without departing from the spirit of the present disclosure. The invention according to the present disclosure is not limited by the above embodiments and is limited only by the claims.

Hereinafter, variations of the invention according to the present disclosure will be described.

[Supplementary Note 1] A lens unit including a mirror frame and a lens accommodated in the mirror frame,
wherein the mirror frame includes a tubular portion in which the lens is accommodated and a lid covering one opening of the tubular portion and including a hole centered on an optical axis of the lens,
the lens includes a lens portion and a flange portion extending to an outer circumference of the lens portion,
a gap is present between an inner wall of the tubular portion and an outer circumference of the lens, and
the lid-side end surface of the flange portion includes, respectively on surfaces parallel to each other or the same plane, an adhesion region adhering to the lid via an adhesive and an abutment region in surface contact with the lid.

[Supplementary Note 2] The lens unit according to Supplementary Note 1, wherein the adhesion region and the abutment region are formed perpendicular to an optical axis direction.

[Supplementary Note 3] The lens unit according to Supplementary Note 1 or 2, wherein the flange portion includes a protrusion on an outer circumference and the adhesion region at the protrusion, the protrusion protruding toward the lid.

[Supplementary Note 4] The lens unit according to Supplementary Note 3, wherein an inner circumferential side surface of the protrusion does not adhere to the lid portion.

[Supplementary Note 5] The lens unit according to any one of Supplementary Notes 1 to 4, wherein the abutment region is located on an outer circumferential side of the adhesion region.

[Supplementary Note 6] The lens unit according to any one of

Supplementary Notes 1 to 5, wherein the lid includes a plate portion extending from an inner wall of the tubular portion in a direction of the hole and including a plane on the lens side of the plate portion, and a protruding portion extending from the plate portion in the direction of the hole and in a direction of the lens.

[Supplementary Note 7] The lens unit according to Supplementary Note 0 6, wherein the flange portion includes a protrusion on an outer circumference, the protrusion protruding toward the lid, and an inner circumferential side surface of the protrusion abuts against the protruding portion.

[Supplementary Note 8] The lens unit according to Supplementary Note 6 or 7, wherein the flange portion includes a protrusion on an outer circumference and the adhesion region at the protrusion, the protrusion protruding toward the lid, and the protruding portion of the lid and the flange portion of the lens are fitted to each other.

[Supplementary Note 9] The lens unit according to any one of Supplementary Notes 1 to 8, wherein the lens unit is for reflow mounting.

[Supplementary Note 10] A lens module including: a substrate: and the lens unit according to any one of Supplementary Notes 1 to 9, wherein the lens module has a structure in which the lens unit is mounted on the substrate.

[Supplementary Note 11] The lens module according to Supplementary Note 10, further including an infrared filter installed at a position covering the hole.

[Supplementary Note 12] A camera module including the lens module according to Supplementary Note 10 or 11.

[Supplementary Note 13] A method of manufacturing a lens module, including mounting the lens unit according to any one of Supplementary Notes 1 to 9 on a substrate through reflow soldering.

### REFERENCE SIGNS LIST

1 Lens unit
2 Mirror frame
21 Tubular portion
22 Lid
221 Plate portion
222 Protruding portion
23 Recess
24 Tubular portion
2a Hole
2b Inner wall
3 Lens
3a Outer circumference
3b Adhesion region
3c, 3d Abutment region
31 Lens portion
32 Flange portion
33 Protrusion
34 Lid-side end surface
4 Lens
5 Adhesive
6 Substrate
7 Infrared filter
8 Adhesive
10 Lens module
11, 12 Lens module group
13 Light-emitting module
14 Light source
15 Diffusion lens

1. A lens unit comprising:
a mirror frame; and
a lens accommodated in the mirror frame,
wherein the mirror frame includes a tubular portion in which the lens is accommodated and a lid covering one opening of the tubular portion and including a hole centered on an optical axis of the lens,
the lens includes a lens portion and a flange portion extending to an outer circumference of the lens portion,
a gap is present between an inner wall of the tubular portion and an outer circumference of the lens, and
the lid-side end surface of the flange portion includes, respectively on surfaces parallel to each other or the same plane, an adhesion region adhering to the lid via an adhesive and an abutment region in surface contact with the lid.

2. The lens unit according to according to claim 1, wherein the adhesion region and the abutment region are formed perpendicular to an optical axis direction.

3. The lens unit according to claim 1, wherein the flange portion includes a protrusion on an outer circumference and the adhesion region at the protrusion, the protrusion protruding toward the lid.

4. The lens unit according to claim 3, wherein an inner circumferential side surface of the protrusion does not adhere to the lid portion.

5. The lens unit according to claim 1, wherein the abutment region is located on an outer circumferential side of the adhesion region.

6. The lens unit according to claim 1, wherein the lid includes a plate portion extending from an inner wall of the tubular portion in a direction of the hole and including a plane on the lens side of the plate portion, and a protruding portion extending from the plate portion in the direction of the hole and in a direction of the lens.

7. The lens unit according to claim 6, wherein
the flange portion includes a protrusion on an outer circumference, the protrusion protruding toward the lid, and
an inner circumferential side surface of the protrusion abuts against the protruding portion.

8. The lens unit according to claim 6, wherein
the flange portion includes a protrusion on an outer circumference and the adhesion region at the protrusion, the protrusion protruding toward the lid, and
the protruding portion of the lid and the flange portion of the lens are fitted to each other.

9. The lens unit according to claim 1, wherein the lens unit is for reflow mounting.

10. A lens module comprising:
a substrate; and
the lens unit according to claim 1,
wherein the lens module has a structure in which the lens unit is mounted on the substrate.

11. The lens module according to claim 10, further comprising an infrared filter installed at a position covering the hole.

12. A camera module comprising
the lens module according to claim 10.

13. A method of manufacturing a lens module, comprising
mounting the lens unit according to claim 1 on a substrate through reflow soldering.
